(19) United States
(12) Patent Application Publication
(10) Pub. No.: US 2013/0138921 A1
(43) Pub. Date: May 30, 2013

(54) DE-COUPLED CO-PROCESSOR INTERFACE

(71) Applicants: Yuan-Yuan Shih, Hsinchu City (TW); Chuan-Hua Chang, Taipei City (TW); Chi-Chang Lai, Hsinchu County (TW)

(72) Inventors: Yuan-Yuan Shih, Hsinchu City (TW); Chuan-Hua Chang, Taipei City (TW); Chi-Chang Lai, Hsinchu County (TW)

(73) Assignee: ANDES TECHNOLOGY CORPORATION, Hsin-Chu City (TW)

(21) Appl. No.: 13/304,705

(22) Filed: Nov. 28, 2011

(51) Int. Cl. G06F 15/76; G06F 9/02

(52) U.S. Cl. 712/34; 712/E09.002

(57) ABSTRACT

A de-coupled co-processor interface (CPIF) is provided. The de-coupled CPIF transfers endian information along with the dispatching of co-processor (COP) instructions. The de-coupled CPIF divides the status report provided by a COP into an early status report and a late status report. The de-coupled CPIF may disable the late status report in order to improve the performance. The de-coupled CPIF further provides multiple early flush interfaces (EFIs) to transfer early flush events from a main processor (MP) to a corresponding COP. As a result, the de-coupled CPIF can improve the performance of the processing of data endian, status reports and early flush events between an MP and a COP.

### BACKGROUND OF THE INVENTION

1. Field of the Invention

The present invention relates to a co-processor interface (CPIF). More particularly, the present invention relates to a high performance de-coupled CPIF.

2. Description of the Related Art

A co-processor (COP) is a specialized processor usually adopted to perform and accelerate special operations such as floating-point calculation and crypto operations for a main processor (MP). Examples of COPs include graphics processing units (GPUs) and digital signal processors (DSPs). In general, the COP and the MP connect by a dedicated CPIF. Through the CPIF, the MP dispatches COP instructions to the COP, passes data and early flush events to the COP, receives status reports from the COP, and notifies the COP of the final decision of whether to commit or flush all non-commitment COP instructions.

When the width of a native data type of the COP is different from the width of a native data type of the MP, the endian of the data should be taken into consideration for data transfer between the MP and the COP. A traditional solution is processing the data by software according to data endian of the MP and the COP. Generally, the software swaps or changes the locations of data in a register. However, the performance of software is relatively low compared to that of hardware. Another traditional solution is providing a global signal to pass the endian from the MP to the COP and then process the data according to the endian in the COP automatically. However, when the MP changes its endian because of, for example, switching to another process, it is not efficient to synchronize the change of endian in the MP with the global signal. Another traditional solution is providing a control bit in the COP to indicate its endian and the control bit is used to guide the hardware to process the data accordingly. Similarly, when the COP changes its endian for some reason, it is not efficient to synchronize the change of endian in the COP with the control bit.

When the MP finds out that a branch prediction is unsuccessful and a COP instruction has to be flushed as a result, the MP passes an early flush event to the COP so that the COP can flush the COP instruction out of the pipeline of the COP. Conventionally, a CPIF has only an early flush interface (EFI) to transmit the early flush events from the MP to the COP and the performance degrades when there are many early flush events generated in different pipeline stage in the MP because some early flush events may take too long to pass the queue of the single EFI to reach the COP and consequently block the COP instructions waiting for the flush-or-no-flush verdict of the early flush events.

The MP must wait for the status reports for some COP instructions. A status report arriving at the MP too late may hinder the execution flow of a COP instruction and degrade the performance.

A CPIF may be designed in coupled or de-coupled form. A coupled CPIF means it is a pipeline-dependent interface. In other words, a coupled CPIF is specialized and optimized for specific pipeline architecture. Each signal transferred by the coupled CPIF is implemented in specific pipeline stages both in the COP and the MP. The coupled CPIF features high performance but is neither scalable nor portable.

On the other hand, a de-coupled CPIF means it is a pipeline-independent interface. Each signal transferred by the de-coupled CPIF is not necessary to be implemented in the specific pipeline stages both in the COP and the MP. The de-coupled CPIF is highly scalable and portable.

### SUMMARY OF THE INVENTION

Accordingly, the present invention is directed to a de-coupled CPIF, which provides a straightforward and high-performance solution to handle data endian between an MP and a COP.

The present invention is also directed to a de-coupled CPIF, which divides the status report provided by a COP into an early status report and a late status report. The de-coupled CPIF may disable the late status report in order to improve the performance. The present invention is also directed to a de-coupled CPIF, which provides multiple EFIs in order to improve the performance of the processing of early flush events.

The present invention is also directed to a de-coupled CPIF, which combines all the functions and features of the aforementioned de-coupled CPIFs in order to improve the performance of the handling of data endian, status reports and early flush events between an MP and a COP.

According to an embodiment of the present invention, a de-coupled CPIF is provided. The de-coupled CPIF handles the execution flow of a COP instruction. An MP dispatches the COP instruction to a COP and the de-coupled CPIF includes a plurality of signal interfaces transmitting a first signal group, a second signal group and a third signal group included in the execution flow of the COP instruction between the MP and the COP. The MP uses the first signal group to dispatch the COP instruction to the COP. The second signal group is used to transfer data corresponding to the COP instruction between the MP and the COP. The MP uses the third signal group to notify the COP of whether to commit the COP instruction or to flush all non-commitment COP instructions in all pipeline stages of the COP. The endian information of the data is provided by the MP or the COP through the signal interfaces.

According to another embodiment of the present invention, another de-coupled CPIF is provided. The de-coupled CPIF includes a plurality of signal interfaces transmitting a first signal group, a second signal group, a third signal group and a fourth signal group included in the execution flow of the COP instruction between the MP and the COP. The MP uses the first signal group to dispatch the COP instruction to the COP. The COP uses the second signal group to provide an early status report to the MP and the COP uses the third signal group to provide a late status report to the MP. The early status report is provided before the late status report. The MP uses the fourth signal group to notify the COP of whether to commit the COP instruction or to flush all non-commitment COP instructions in all pipeline stages of the COP.

According to another embodiment of the present invention, another de-coupled CPIF is provided. The de-coupled CPIF includes one or a plurality of EFIs coupled between at least one stage of a pipeline of the MP and at least one stage of a pipeline of the COP. The EFIs transmit at least one signal group included in the execution flow of the COP instruction between the MP and the COP. The MP uses the signal group to pass early flush events to the COP. The early flush events notify the COP that a COP instruction passes the corresponding EFI or to flush all COP instructions which do not pass the corresponding EFI.

According to another embodiment of the present invention, another de-coupled CPIF is provided. This de-coupled CPIF includes all the functions and features of the aforementioned de-coupled CPIFs and features all the advantages and effects of the aforementioned de-coupled CPIFs.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing a de-coupled CPIF according to an embodiment of the present invention.

FIG. 2 is a schematic diagram showing signal groups between a main processor and a co-processor according to an embodiment of the present invention.

FIG. 3 and FIG. 4 are examples of interface protocols of two signal groups between a main processor and a co-processor according to an embodiment of the present invention.

FIG. 5, FIG. 6 and FIG. 7 are schematic diagrams showing early flush interfaces according to various embodiments of the present invention.

FIG. 8 is a schematic diagram showing the signal groups for delivering early status reports and late status reports from a co-processor to a main processor according to an embodiment of the present invention.

FIG. 9 is a schematic diagram showing the signal groups for delivering early status reports and late status reports from a co-processor to a main processor according to another embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

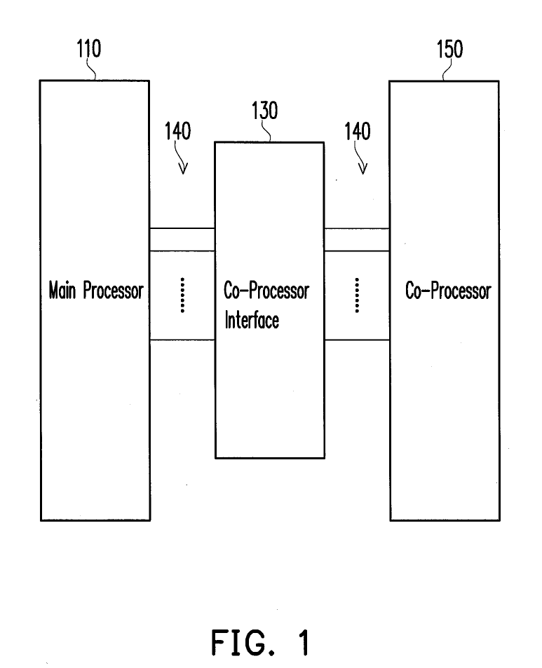

FIG. 1 is a schematic diagram showing a de-coupled CPIF 130 according to an embodiment of the present invention. The de-coupled CPIF 130 is coupled between an MP 110 and a COP 150. Whenever the MP 110 dispatches a COP instruction to the COP 150, the CPIF 130 handles the execution flow of the COP instruction. The de-coupled CPIF 130 includes a plurality of signal interfaces 140 for transmitting signal groups included in the execution flow of the COP instruction between the MP 110 and the COP 150.

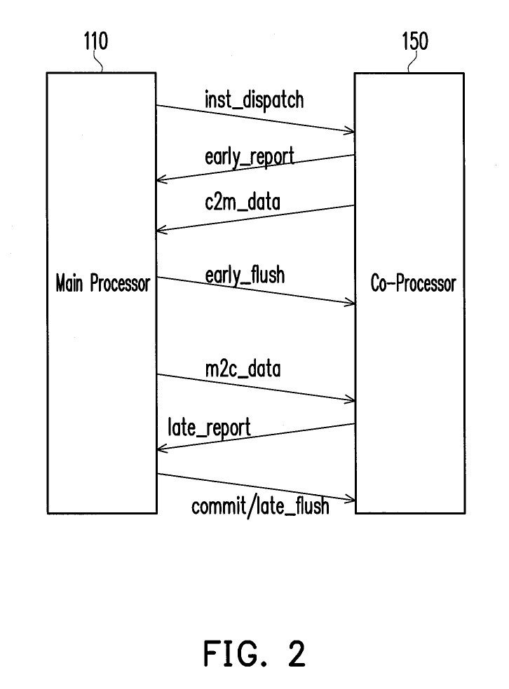

FIG. 2 is a schematic diagram showing an example of signal groups used in the execution flow of COP instructions according to an embodiment of the present invention. As shown in FIG. 2, the MP 110 uses the signal group inst_dispatch to dispatch COP instructions to the COP 150. The COP 150 uses the signal group early_report to provide early status reports to the MP 110. The COP 150 uses the signal group c2m_data to transfer data corresponding to the COP instructions to the MP 110. The MP 110 uses the signal group early_flush to pass early flush events of the COP instructions to the COP 150. The MP 110 uses the signal group m2c_data to transfer data corresponding to the COP instructions to the COP 150. The COP 150 uses the signal group late_report to provide late status reports to the MP 110. The MP 110 uses the signal group commit/late_flush to notify the COP 150 of whether a corresponding COP instruction can be committed or to flush all non-commitment COP instructions in all pipeline stages of the COP 150. In some other embodiments of the present invention, the signals related to the aforementioned commitment notification may constitute an individual signal group and the signals related to the aforementioned flush notification may constitute another individual signal group. The signal interfaces 140 of the CPIF 130 transmit all the signal groups mentioned above between the MP 110 and the COP 150.

A COP instruction may trigger an early status report and a late status report from the COP that executes the COP instruction. An early status report corresponding to a COP instruction is always generated and provided to the MP no later than the late status report corresponding to the same COP instruction. Both the early status report and the late status report are used to notify the MP whether or not an abnormal status that can affect the execution flow of the corresponding COP instruction such as error, exception or trap occurs in the COP during the execution of the COP instruction. The late status report is generated in the last stage of the pipeline of the COP where an abnormal status can happen, while the early status report may be generated in any stage of the pipeline of the COP including the last stage.

In this embodiment of the present invention, the COP provides the early status reports and the late status reports as traps to the MP. In this scenario, traps are better than interrupts. Traps can enter the MP directly, while interrupts must pass through an external interrupt controller first and then reach the MP.

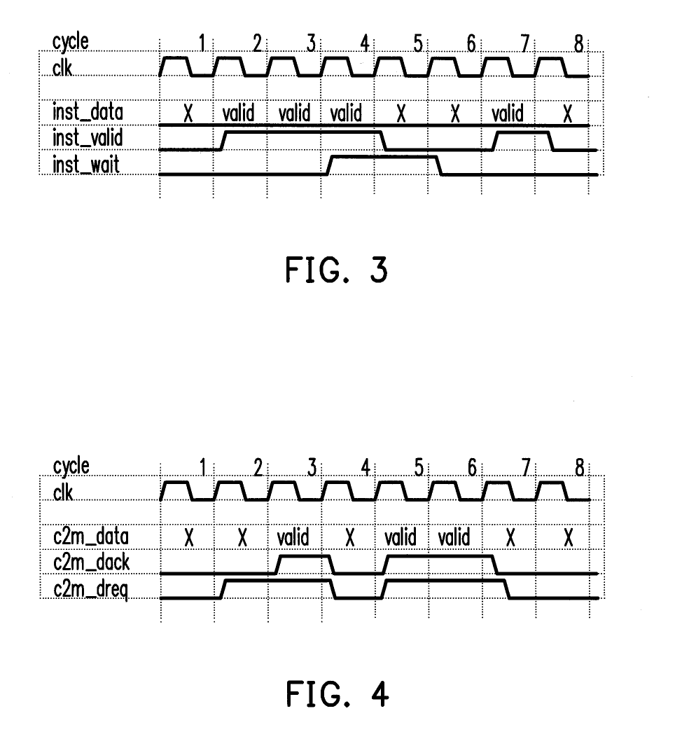

A signal group is a set of signals used by the MP and the COP for handshaking according to predetermined interface protocols. FIG. 3 is an example of the interface protocol of the signal group inst_dispatch used to dispatch COP instructions from the MP 110 to the COP 150 in FIG. 2. The MP 110 uses the signal inst_valid to indicate a valid COP instruction appears on the signal inst_data. The MP 110 uses the signal inst_data to deliver the COP instruction. The COP 150 uses the signal inst_wait to indicate the COP 150 is busy and can not accept new instruction at the next clock cycle. As shown in FIG. 3, the MP 110 asserts inst_valid in the second, third and fourth clock cycles. Also in each cycle of the second, third and fourth clock cycles, the MP 110 dispatches a COP instruction to the COP 150 on the signal inst_data. In the fourth and fifth clock cycles, the COP 150 asserts the signal inst_wait to notify the MP 110 to suspend the dispatching. Therefore, the MP 110 stops dispatching the COP instruction in the fifth and sixth clock cycles and then resumes the instruction dispatching in the seventh clock cycle.

FIG. 4 is an example of the interface protocol of the signal group c2m_data used to transfer data from the COP 150 to the MP 110 in FIG. 2. The MP 110 uses the signal c2m_dreq to indicate the MP 110 is expecting the data from the COP 150. The COP 150 uses the signal c2m_data to deliver the data and uses the signal c2m_dack to indicate the data sent by c2m_data are valid. As shown in FIG. 4, the MP 110 asserts the signal c2m_dreq in the second clock cycle to request data and continually asserts it in the third clock cycle as the COP 150 does not respond with valid data in the second clock cycle. The COP 150 asserts the signal c2m_dack and transmits valid data on the signal c2m_data in the third clock cycle when it has valid data to respond. The COP 150 stops sending data in the fourth clock cycle, while the MP 110 deasserts signal c2m_dreq in the same cycle as it requires no data in that cycle. The MP 110 asserts the signal c2m_dreq again in the fifth clock cycle at the same time the COP 150 has valid data and asserts the signal c2m_dack and puts the data on the signal c2m_data in the fifth clock cycle. The COP 150 continually sends data at the sixth clock cycle with c2m_dack asserted and the data is received by MP 110 in the same cycle as it happens to assert c2m_dreq for expecting the data in that cycle.

In this embodiment, when a COP instruction requires endian information to resolve the order of data, the MP 110 provides the endian information of the data through the signal interfaces 140 to the COP 150. The MP 110 may incorporate the endian information into the signal group inst_dispatch or the signal group m2c_data in order to transfer the endian information to the COP 150. In some other embodiments of the present invention, the endian information may be provided by the COP 150 to the MP 110. The COP 150 may use the signal group c2m_data to provide the endian information. Alternatively, the execution flow of COP instructions may include another individual signal group transmitted between the MP 110 and the COP 150. The MP 110 or the COP 150 may use the individual signal group to transfer the endian information between the MP 110 and the COP 150.

The signal interfaces 140 of the de-coupled CPIF 130 may include a plurality of EFIs coupled between at least one stage of a pipeline of the MP 110 and at least one stage of a pipeline of the COP 150. The EFIs may transmit at least one signal group included in the execution flow of the COP instruction between the MP 110 and the COP 150. The MP 110 may use the signal group to pass early flush events to the COP 150. The early flush events notify the COP 150 that a COP instruction passes the corresponding EFI or to flush all COP instructions which do not pass the corresponding EFI. In order to improve performance, the de-coupled CPIF 130 may pass early flush events of the COP instruction from the MP 110 to the COP 150 immediately when the early flush events are generated in the pipeline stages of the MP 110.

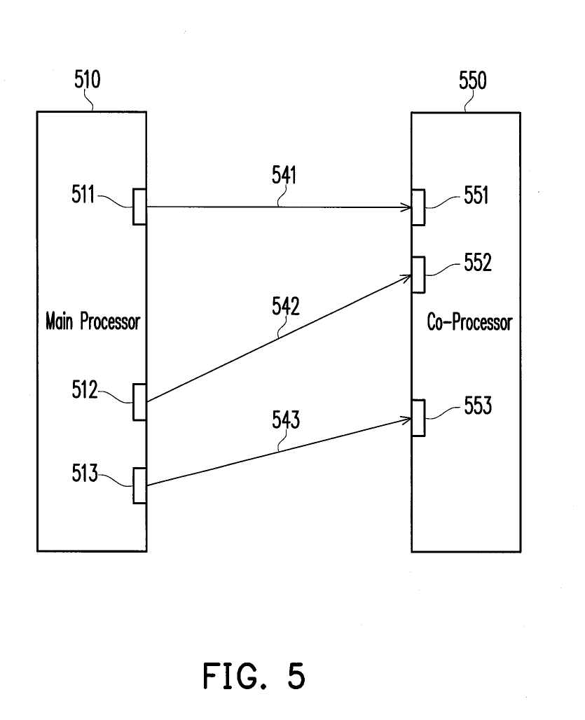

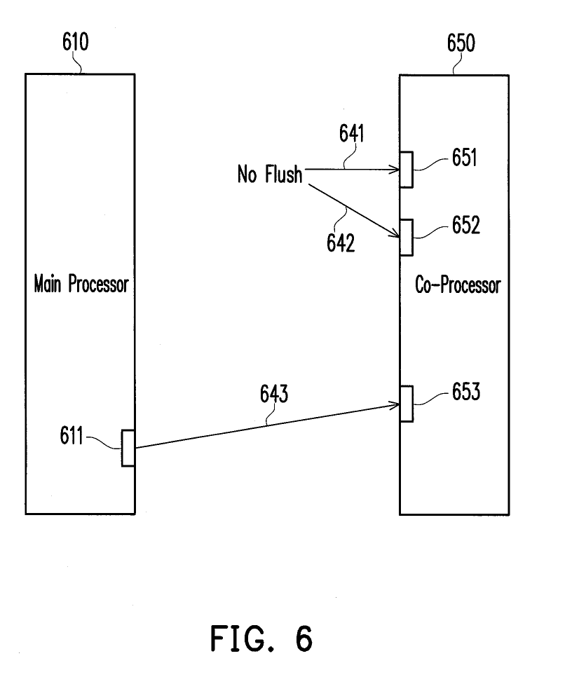

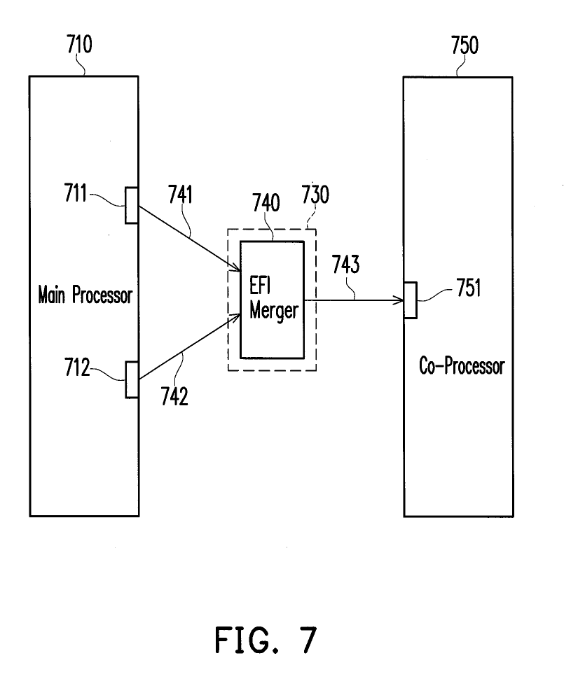

In an embodiment of the present invention, the EFIs may be coupled between a plurality of predetermined stages of the pipeline of the MP and a plurality of predetermined stages of the pipeline of the COP. Each EFI may pass an early flush event from a different one of the predetermined stages of the pipeline of the MP to a different one of the predetermined stages of the pipeline of the COP. For example, in FIG. 5, there are three predetermined stages in the pipeline of the MP 510 that can generate early flush events, namely the stages 511, 512 and 513. The predetermined stages 511, 512 and 513 correspond to the predetermined stages 551, 552 and 553 of the pipeline of the COP 550, respectively. The de-coupled CPIF connecting the MP 510 and the COP 550 includes three EFIs 541, 542 and 543. The EFI 541 passes early flush events from the pipeline stage 511 of the MP 510 to the pipeline stage 551 of the COP 550. The EFI 542 passes early flush events from the pipeline stage 512 of the MP 510 to the pipeline stage 552 of the COP 550. The EFI 543 passes early flush events from the pipeline stage 513 of the MP 510 to the pipeline stage 553 of the COP 550.

When a COP instruction enters any one of the pipeline stages 551, 552 and 553 of the COP 550, before entering the next pipeline stage, the COP instruction must wait for the flush-or-no-flush verdict of the corresponding early flush event from the corresponding pipeline stage of the MP 510. The EFIs in FIG. 5 provide multiple parallel paths so that the MP 510 can pass early flush events generated in different pipeline stages to the COP 550 immediately without blocking the execution flow of any COP instruction.

In another embodiment of the present invention, a particular EFI may be coupled between a single predetermined stage of the pipeline of the MP and a particular one of a plurality of predetermined stages of the pipeline of the COP to pass the early flush event from the predetermined stage of the pipeline of the MP to the particular predetermined stage of the pipeline of the COP. Each of the other EFIs may be coupled to a different one of the other predetermined stage of the pipeline of the COP to provide a dummy early flush event indicating no flush to the corresponding predetermined stage of the pipeline of the COP. For example, in FIG. 6, the MP 610 has a predetermined pipeline stage 611 that can generate early flush events. The COP 650 has three predetermined pipeline stages 651-653 for receiving early flush events. The de-coupled CPIF connecting the MP 610 and the COP 650 includes three EFIs 641-643. The EFI 643 passes early flush events from the pipeline stage 611 of the MP 610 to the pipeline stage 653 of the COP 650. The EFIs 641 and 642 provide dummy early flush events indicating no flush to the pipeline stages 651 and 652 of the COP 650, respectively.

In the example of FIG. 6, the EFI 643 may be coupled to any one of the pipeline stages 651-653 of the COP 650 and the other two of the pipeline stages 651-653 simply receive the dummy early flush event. In order to avoid instruction blocking, it is preferable to couple the EFI transmitting the early flush event from the MP to a stage near the end of the pipeline of the COP. For example, the EFI transmitting the early flush event from the MP may be coupled to the last one of the aforementioned predetermined stages of the pipeline of the COP.

In another embodiment of the present invention, the EFIs may be coupled between a plurality of predetermined stages of the pipeline of the MP and a single predetermined stage of the pipeline of the COP. The de-coupled CPIF connecting the MP and the COP may collect an early flush event from each of the predetermined stages of the pipeline of the MP and then provides a summary event to the predetermined stage of the pipeline of the COP according to the early flush events collected from the MP. For example, in FIG. 7, the de-coupled CPIF 730 connecting the MP 710 and the COP 750 includes an EFI merger 740. The EFI merger 740 collects early flush events from the predetermined pipeline stages 711 and 712 of the MP 710 through the EFIs 741 and 742 respectively, and then the EFI merger 740 provides a summary event through the EFI 743 to the predetermined pipeline stage 751 of the COP 750 according to the collected early flush events. The summary event indicates “flush” when at least one of the early flush events collected from the MP indicates “flush”, while the summary event indicates “no flush” when each early flush event collected from the MP indicates “no flush”.

As mentioned above, the COP may provide an early status report and a late status report to the MP in response to a COP instruction to indicate whether or not an abnormal status occurs during the execution of the COP instruction. In some circumstances, the late status report may be disabled to improve performance. For example, when it is known previously that the COP instruction does not generate any abnormal status for the late status report, or the generation of the abnormal status is disabled, or the abnormal status generated by the COP instruction is too trivial to affect the execution flow of the COP instruction, the COP may disable the late status report. When the late status report is disabled in this way, the performance of the MP can be higher because the MP does not have to wait idly for the late status report.

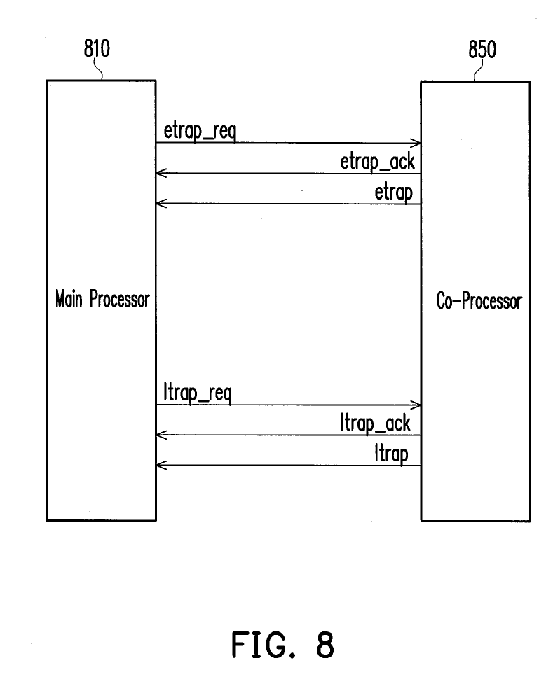

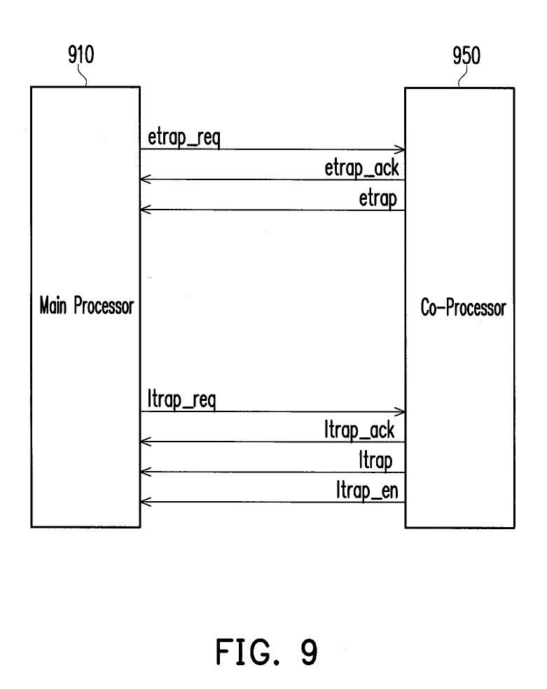

FIG. 8 and FIG. 9 are schematic diagrams showing the signal groups used for both the early status report and the late status report and the mechanism for disabling the late status report according to two different embodiments of the present invention. In FIG. 8, the signal group for the early status report includes the signals etrap_req, etrap_ack and etrap. The MP 810 uses the signal etrap_req to request for the early status report for each COP instruction. The COP 850 uses the signal etrap_ack to indicate that the contents of the signal etrap is valid and uses the signal etrap to deliver the early status report to the MP 810. Similarly, the signal group for the late status report includes the signals ltrap_req, ltrap_ack and ltrap. The MP 810 uses the signal ltrap_req to request for the late status report for each COP instruction. The COP 850 uses the signal ltrap_ack to indicate that the contents of the signal ltrap is valid and uses the signal ltrap to deliver the late status report to the MP 810. The COP 850 may disable the late status report by always asserting the signal ltrap_ack and always reporting there is no abnormal status in the signal ltrap.

The embodiment of FIG. 9 differs from the embodiment of FIG. 8 in that the signal group for the late status report includes an additional signal ltrap_en that indicates whether the late status report is enabled or disabled. The COP 950 may disable the late status report by de-asserting the signal ltrap_en.

The de-coupled CPIF in the embodiments above transfers the endian information along with the corresponding COP instruction to the COP so that the order of data can be properly arranged. The aforementioned de-coupled CPIF provides multiple EFIs so that early flush events generated in different pipeline stages of the MP can be transferred to the COP simultaneously without blocking the execution of any COP instruction. The aforementioned de-coupled CPIF can disable late status reports to improve the performance of the MP. In summary, the present invention provides a de-coupled CPIF that is scalable and portable and features high performance.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A de-coupled co-processor interface (CPIF) handling an execution flow of a co-processor (COP) instruction, wherein a main processor (MP) dispatches the COP instruction to a COP and the de-coupled CPIF comprises:
a plurality of signal interfaces transmitting a first signal group, a second signal group and a third signal group included in the execution flow of the COP instruction between the MP and the COP, wherein the first signal group is used by the MP to dispatch the COP instruction to the COP, the second signal group is used to transfer data corresponding to the COP instruction between the MP and the COP, the third signal group is used by the MP to notify the COP of whether to commit the COP instruction or to flush all non-commitment COP instructions in all pipeline stages of the COP, wherein an endian information of the data is provided by the MP or the COP through the signal interfaces.

2. The de-coupled CPIF of claim 1, wherein the MP also uses the first signal group or the second signal group to transfer the endian information to the COP.

3. The de-coupled CPIF of claim 1, wherein the COP also uses the second signal group to transfer the endian information to the MP.

4. The de-coupled CPIF of claim 1, wherein the signal interfaces further transmit a fourth signal group included in the execution flow of the COP instruction between the MP and the COP, and the fourth signal group is used to transfer the endian information between the MP and the COP.

5. A de-coupled co-processor interface (CPIF) handling an execution flow of a co-processor (COP) instruction, wherein a main processor (MP) dispatches the COP instruction to a COP and the de-coupled CPIF comprises:
a plurality of signal interfaces transmitting a first signal group, a second signal group, a third signal group and a fourth signal group included in the execution flow of the COP instruction between the MP and the COP, wherein the MP uses the first signal group to dispatch the COP instruction to the COP, the COP uses the second signal group to provide an early status report to the MP and the COP uses the third signal group to provide a late status report to the MP, the early status report is provided before the late status report, and the MP uses the fourth signal group to notify the COP of whether to commit the COP instruction or to flush all non-commitment COP instructions in all pipeline stages of the COP.

6. The de-coupled CPIF of claim 5, wherein the COP provides the early status report and the late status report as traps to the MP.

7. The de-coupled CPIF of claim 5, wherein the late status report is generated in a last stage of a pipeline of the COP where an abnormal status that can affect the execution flow of the COP instruction can happen, and the early status report is generated in a stage of the pipeline before the last stage.

8. The de-coupled CPIF of claim 7, wherein the COP disables the late status report when the COP instruction does not generate the abnormal status.

9. The de-coupled CPIF of claim 8, wherein the COP disables the late status report by always reporting there is no abnormal status in the third signal group.

10. The de-coupled CPIF of claim 8, wherein the third signal group comprises an enable signal and the COP disables the late status report by de-asserting the enable signal.

11. A de-coupled co-processor interface (CPIF) handling an execution flow of a co-processor (COP) instruction, wherein a main processor (MP) dispatches the COP instruction to a COP and the de-coupled CPIF comprises:
one or a plurality of early flush interfaces (EFIs) coupled between at least one stage of a pipeline of the MP and at least one stage of a pipeline of the COP, wherein the EFIs transmit a signal group included in the execution flow of the COP instruction between the MP and the COP, the MP uses the signal group to pass early flush events to the COP and the early flush events notify the COP that the COP instruction passes the corresponding EFI or to flush all COP instructions which do not pass the corresponding EFI.

12. The de-coupled CPIF of claim 11, wherein the EFIs are coupled between a plurality of predetermined stages of the pipeline of the MP and a plurality of predetermined stages of the pipeline of the COP, each of the EFIs passes an early flush event from a different one of the predetermined stages of the pipeline of the MP to a different one of the predetermined stages of the pipeline of the COP.

13. The de-coupled CPIF of claim 11, wherein a particular one of the EFIs is coupled between a predetermined stage of the pipeline of the MP and a particular one of a plurality of predetermined stages of the pipeline of the COP to pass an early flush event from the predetermined stage of the pipeline of the MP to the particular predetermined stage of the pipeline of the COP, each of the other EFIs is coupled to a different one of the other predetermined stage of the pipeline of the COP to provide a dummy early flush event indicating no flush to the corresponding predetermined stage of the pipeline of the COP.

14. The de-coupled CPIF of claim 11, wherein the EFIs are coupled between a plurality of predetermined stages of the pipeline of the MP and a predetermined stage of the pipeline of the COP, the de-coupled CPIF collects an early flush event from each of the predetermined stages of the pipeline of the MP and provides a summary event to the predetermined stage of the pipeline of the COP according to the early flush events collected from the MP.

15. The de-coupled CPIF of claim 14, wherein the summary event indicates flush when at least one of the early flush events collected from the MP indicates flush, and the summary event indicates no flush when each of the early flush events collected from the MP indicates no flush.

16. A de-coupled co-processor interface (CPIF) handling an execution flow of a co-processor (COP) instruction, wherein a main processor (MP) dispatches the COP instruction to a COP and the de-coupled CPIF comprises:
a plurality of signal interfaces transmitting a first signal group, a second signal group, a third signal group, a fourth signal group and a fifth signal group included in the execution flow of the COP instruction between the MP and the COP, wherein
the first signal group is used by the MP to dispatch the COP instruction to the COP, the second signal group is used to transfer data corresponding to the COP instruction between the MP and the COP, wherein an endian information of the data is provided by the MP or the COP through the signal interfaces,
the COP uses the third signal group to provide an early status report to the MP and the COP uses the fourth signal group to provide a late status report to the MP, the early status report is provided before the late status report,
the MP uses the fifth signal group to notify the COP of whether to commit the COP instruction or to flush all non-commitment COP instructions in all pipeline stages of the COP,
the signal interfaces comprises one or a plurality of early flush interfaces (EFIs) coupled between at least one stage of a pipeline of the MP and at least one stage of a pipeline of the COP, the EFIs transmit a sixth signal group included in the execution flow of the COP instruction between the MP and the COP, the MP uses the sixth signal group to pass early flush events of the COP instruction to the COP and the early flush events notify the COP that the COP instruction passes the corresponding EFI or to flush all COP instructions which do not pass the corresponding EFI.
